(19) United States
(12) Patent Application Publication
(10) Pub. No.: US 2006/0273918 A1
(43) Pub. Date: Dec. 7, 2006

(54) System for providing multiple maintenance profiles using wireless communications

(76) Inventors: Satish N. Ram, Poway, CA (US); Loyie H. Sims III, Valley Center, CA (US); Robert D. McCloskey, Lawrenceville, GA (US)

Correspondence Address: QUALCOMM INCORPORATED, 5775 MOREHOUSE DR., SAN DIEGO, CA, 92121, US

(21) Appl. No.: 11/231,000

(22) Filed: Sep. 19, 2005

Related U.S. Application Data
(60) Provisional application No. 60/688,400, filed on Jun. 7, 2005.

(51) Int. Cl. G08B 21/00

(52) U.S. Cl. 340/679

(57) ABSTRACT

A wireless equipment management system is provided which creates multiple maintenance schedules that are independently driven based on monitored equipment information such as equipment usage hours and fault codes. The schedules are particularly useful in arranging maintenance of mobile equipment located in the field.

### RELATED APPLICATIONS

This application claims priority to U.S. Provisional Application No. 60,688,400, filed on Jun. 7, 2005.

### BACKGROUND OF THE INVENTION

Monitoring and managing equipment in remote locations presents a challenging task, particularly for equipment leasing companies. This task becomes even more challenging when it involves mobile equipment such as heavy construction vehicles. Creating maintenance schedules and the mechanisms by which the scheduling can be carried out can be complicated, especially for that concerning mobile equipment.

Presently, systems are known which generate a single maintenance schedule for a piece of equipment. For instance, in the case of a construction vehicle, a single maintenance schedule is created for the entire vehicle. In instances where the vehicle is located remotely away from the maintenance service center usually involved in the servicing of the vehicle, generating maintenance schedules which are easily created, distributed and followed proved difficult until now.

### BRIEF DESCRIPTION OF THE DRAWINGS

FIG. 1 illustrates a block diagram of an equipment management system.

FIG. 2 illustrates a maintenance schedule as it pertains to a piece of monitored equipment, in this case, the engine of a Year 2000 Model 370 Peterbilt truck.

FIG. 3 is a block diagram illustrating how each sensor and/or controller on a piece of equipment is used to monitor or control a piece of equipment or system or function on a piece of equipment.

Applicable reference numbers have been carried forward.

### DETAILED DESCRIPTION

A wireless equipment management system 2 is provided for managing a plurality of equipment 4, e.g., mobile or non-mobile machines.

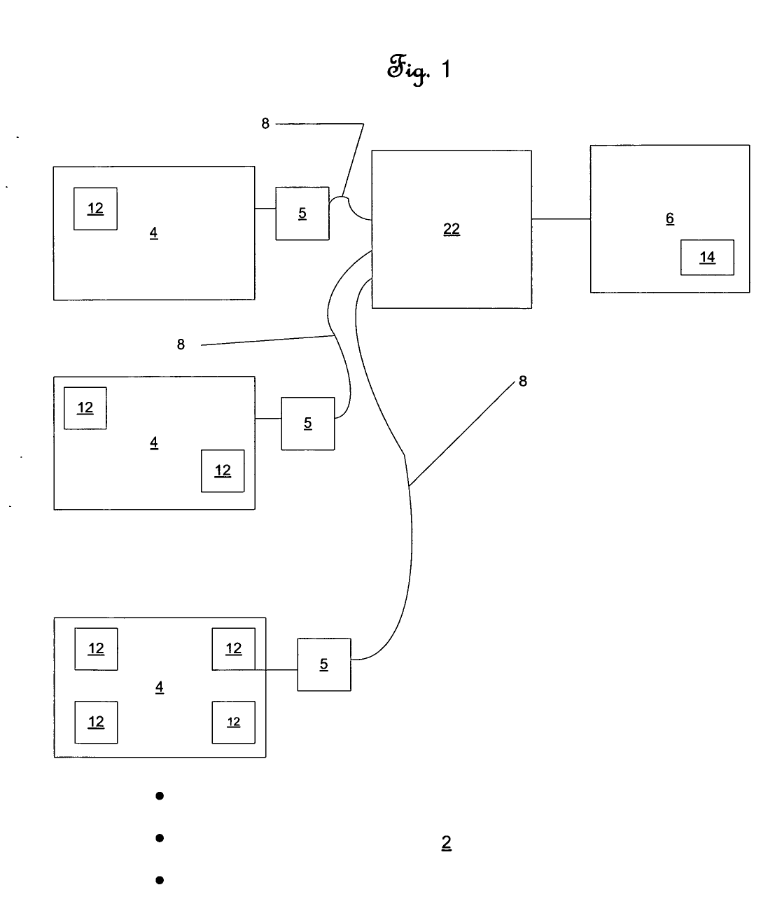

FIG. 1 illustrates a block diagram of equipment management system 2. FIG. 1 shows a plurality of monitored equipment 4 (coupled to data processing center 6 through wireless communications link 8 represented by arrows. Equipment 4 can represent heavy equipment, office equipment, surface, land and air vehicles, etc. This includes engines, automobiles, trucks, construction, agricultural or earthmoving equipment, computers, consumer electronics, copiers, printers, facsimile machines, et cetera (communications link 8 can include a satellite data link, an analog cellular telephone communications link (using, for instance, frequency division multiple access (FDMA), a digital cellular communications link (using e.g., code division multiple access (CDMA), time division multiple access (TDMA), etc.) a radio link, Bluetooth, Wi-fi(802.11 a, 802.11b, 802.11 g etc.), or a combination thereof. Data processing center 6 receives status information related to monitored equipment 4. In one aspect, each monitored piece of equipment 4 can include one or more sensors 12 for measuring equipment usage or operating characteristics. In one embodiment, data processing center 6 receives signals, via communications link 8 from the one or more sensors 12, containing data relating to equipment usage and/or operating characteristics. The received data is stored at data processing center 6 which can adaptively manage maintenance scheduling for each piece of monitored equipment 4 based on data from sensors 12. For example, one of equipment 4 shown could represent an engine wherein a sensor 12 measures odometer mileage. Another sensor 12 can measure, for instance, ambient operating temperatures. An oil change schedule and an oil type can be calculated at data processing center 6 based upon the data supplied by sensors 12. For instance under predominantly and relatively high ambient temperatures, a higher weight oil and more frequent oil change scheduling at shorter odometer mileage intervals between scheduled oil changes may be prescribed to reduce engine wear. Predominantly cooler ambient temperatures over longer odometer readings may dictate a lower weight oil with more miles between oil changes. Consequently, an engine or piece of heavy equipment operating in area near the Sahara Desert in Africa could have an entirely different maintenance schedule from the same engine operating in Iceland as determined by processing center 6. Alternatively, in the case of a copier or facsimile machine sensor 12 can measure toner levels and copier usage hours to adaptively determine toner cartridge replacement scheduling and/or ordering.

Data processing center 6 can contain one or more servers which operate to run computer programs that manage and/or prepare equipment maintenance schedules for a plurality of equipment 4. Equipment operating data, historical usage data, maintenance schedules and equipment location information can also be tracked and maintained by one or more servers at data processing center 6.

Equipment manager 14 within data processing center 6 can be implemented as a server programmed to calculate servicing schedules for each monitored piece of equipment 4. Data on each monitored piece of equipment can be maintained in memory storage represented by functional block 16 as accomplished, for instance, in the same server as that for equipment manager 14 or in a separate server therefrom for storage of collected data. This data includes equipment specifications, and operating data including historical usage data. For instance, information relating to repair histories, in-service hours, fuel consumption, location information and operating costs can be stored in memory storage 16.

A particular advantage of wireless equipment management system 2 lies in its ability to generate multiple maintenance schedules that are independently, adaptively, and automatically driven from equipment information collected by sensors 12. Multiple schedules per equipment piece allow for easier tracking, initiation of new maintenance procedures and analysis. In the case of an engine, multiple schedules can be generated for oil changes, spark plug replacement, part replacement, etc. For the case of a construction vehicle, one or more sensors 12 can, for instance, monitor braking systems. One maintenance schedule can pertain to turning of rotors for disc brakes or perhaps for replacement of brake pads. Another schedule may pertain to tire inspection and/or replacement, etc. It may be inconvenient or infeasible for an equipment manager or owner to handle certain maintenance procedures in-house. Typically, maintenance work for equipment in the field is outsourced to various specialty outfits. A tire contractor may handle all of the outsourced tire work for a company in a particular region or part of the world. Braking mechanism maintenance, whether for an air brake or otherwise may be contracted to a specialist. A single maintenance schedule for a piece of equipment can simply be insufficient, particularly in instances where maintenance work is contracted out or rather, outsourced. In order to assign and monitor the contracted work, a maintenance schedule for a particular type of maintenance work on a specific vehicle should be forwarded to a specific contractor, e.g. engine maintenance schedules for twenty vehicles identified operating in Central America. Further, with an ever increasing eye toward security, an owner or manager of equipment may not want the entire maintenance schedule of a piece of equipment readily available to all that perform maintenance work. This may be especially the case with maintenance of security or military vehicles.

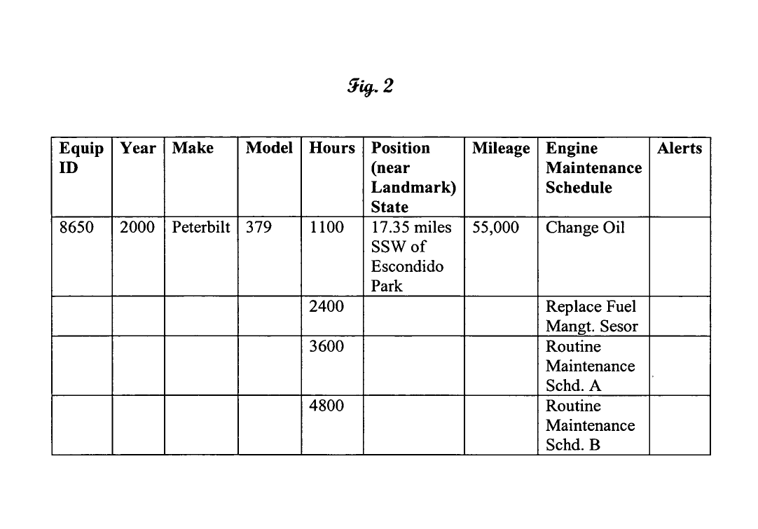

FIG. 2 illustrates a maintenance schedule as it pertains to a piece of monitored equipment, in this case, the engine of a Year 2000 Model 370 Peterbuilt truck. Data can be displayed in a message, an electronic report etc. for dispatch to an entity monitoring equipment or directly to personnel responsible for providing maintenance service, e.g. engine servicing contractor. The data fields shown for display can be selected as required or desired. A similar schedule can be generated for other functions requiring servicing such as vehicle tire or vehicle transmission equipment.

Wireless equipment system 2 is preferably a computer-based system that uses the Transmission Control Protocol/Internet Protocol (TCP/IP) networking protocol. Further this system 2 is particularly suitable for the Internet, particularly with broadband Internet. Wireless system 2 is accessible from multiple sources concerning maintenance scheduling. Different levels of security can be meted out to each system user depending on information needs et cetera.

Wireless equipment system 2 can be implemented using a combination of wireless technology, data handling functionality construction industry constructs as provided, for example, by an equipment management solution such as GlobalTRACS® by QUALCOMM®. An equipment management solution automatically collects, organizes and transmits vital information concerning how the equipment is being used, how much equipment is being used as well as the location of that equipment. This information is especially useful to entities renting, distributing, contracting or owning equipment-particularly construction equipment. The equipment management solution can track equipment use such as engine hour use as reported by a sensor tracking usage hours of a system on a piece of equipment, such as an engine. Further, the equipment management solution can provide global positioning system (GPS)-based equipment location information including data indicating when a piece of equipment has moved outside of a pre-set boundary.

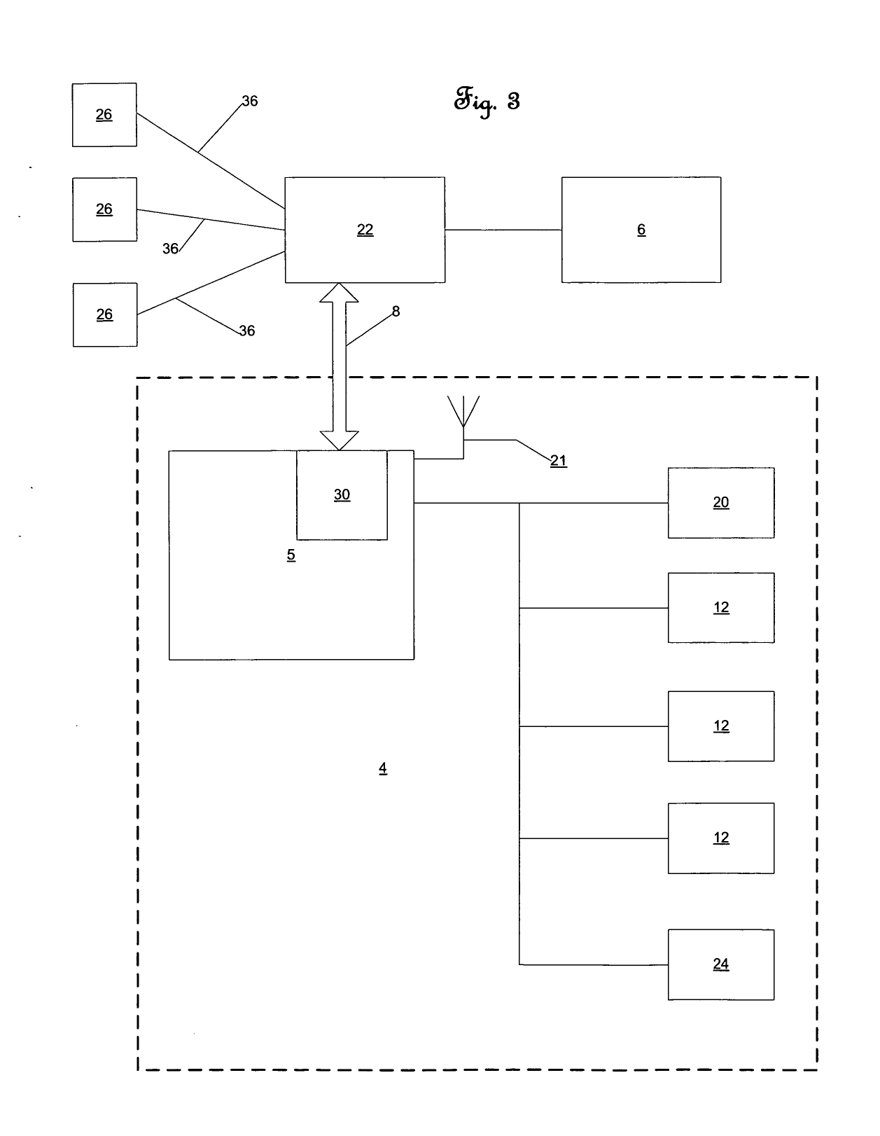

FIG. 3 is a block diagram of illustrating how each sensor 12 and/or controller 20 on a piece of equipment is used to monitor or control a piece of equipment or system or function on a piece of equipment. In one embodiment, each sensor 12 and controller 20 on a piece of equipment 4 is connected through a controller area network (CAN).

In one embodiment each sensor 12 and controller 20 on the same piece of equipment can act as a CAN slave device connected to a CAN master controller 5. Master controller 5 includes antenna 18 which is used in connection with transmitting and receiving Code Division Multiple Access (CDMA) signals. However, other communications systems for use in connection with antenna 18 are contemplated, e.g., Time Division Multiple Access, et cetera.

Data received by each sensor 12 on a piece of equipment 4 is sent to CAN master controller 5 where it is stored until downloaded by system controller 22 through wireless communications link 8.

Operator controller 24 receives alerts in the form of warning messages, instructions, alarms, etc. to warn an equipment operator (not shown) of conditions (faulty operation, etc.) sensed on equipment 4 by a sensor 12, thereby allowing the operator to take or institute corrective or preventative action.

Equipment manager 14 in conjunction with data processing center 6 analyzes data received from each CAN master controller 5. As a result thereof, equipment manager 14 issues, inter alia, maintenance recommendations, alerts, alarms to system controller 22 which in turn forwards the same to a user control/monitoring site 26. A control/monitoring site 26 can represent, for instance, the owner of rental equipment. Through link 36, communications can be had between each control/monitoring site 26 and equipment manager 14 through system controller 22 pertaining to a specified piece of equipment 4. Communications over link 36 can occur by numerous ways. For instance, these communications can occur over the Internet, via e-mail, text messages, etc. Equipment manager 14 function can adapt to inputs, requests, etc. from control/monitoring sites 26. For instance, a maintenance step can be moved up ahead of schedule at the request of a control/monitoring site 26.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A management system for equipment comprising:
a processor located remotely from said equipment;
at least one sensor being operable to sense operating condition information pertaining to said equipment; and
a wireless communication system being operable to provide communications among said processor, said sensor, and said equipment, said processor being operable to generate multiple maintenance schedules for said equipment in connection with said processor receiving equipment operating data from said at least one sensor.

2. A management system for equipment as recited in claim 1 wherein said multiple maintenance schedules are further generated in connections with said processor processing equipment maintenance history information.

3. A management system for equipment as recited in claim 2 wherein said multiple maintenance schedules are further generated in connection with said processor processing equipment information.

4. A management system for equipment as recited in claim 1 wherein said multiple maintenance schedules are further generated in connection with said processor processing equipment information.

5. A management system for equipment as recited in claim 1 wherein said equipment is selected from the group consisting of heavy equipment, office equipment and surface, land and air vehicles.

6. A management system for equipment as recited in claim 5 wherein a maintenance schedule from said multiple maintenance schedules pertains to maintenance of one from the group consisting of tires, engines, transmissions, fuel, undercarriage and other components.

7. A management system as recited in claim 1 wherein said maintenance schedules are adaptively alterable based upon said processor receiving operating condition information from said at least one sensor.

8. A method of doing business comprising:
electronically monitoring, using a computer system, equipment from a remote location;
generating a plurality of maintenance schedules for said equipment and electrically dispatching a selected maintenance schedule to a designated maintenance entity.

9. A method of doing business as recited in claim 8 wherein said maintenance entity comprises a service contractor.

10. A method of doing business as recited in claim 9 wherein said contractor is selected from the group consisting of engine servicing personnel, transmission servicing personnel, fuel servicing personnel, tire servicing personnel and general equipment maintenance personnel.

11. A method of doing business as recited in claim 8 wherein said equipment is monitored using a wireless communication system.

12. A method of doing business as recited in claim 11 wherein said wireless communications system is a mobile communications system selected from the group consisting of a Code Division Multiple Access (CDMA) communications system, a Time Division Multiple Access (TDMA) system, a Frequency Division Multiple Access System (FDMA), a satellite communications system and a two-way radio communications system.

13. A method of doing business as recited in claim 8 wherein said equipment is selected from the group consisting of heavy equipment, office equipment and surface, land and air vehicles.

14. A method of doing business as recited in claim 13 wherein said equipment further consists of engines, consumer electronics, automobiles, trucks, construction, agricultural and earthmoving equipment.

15. A method of doing business as recited in claim 6 wherein said office equipment is selected from the group consisting of computers, copiers, printers, and facsimile machines.

16. A method of doing business as recited in claim 1 wherein a maintenance schedule from said multiple maintenance schedule pertains to maintenance of one from the group consisting of tires, engines, fuel, transmissions and other components.

17. A method of doing business as recited in claim 8 wherein electronically monitoring equipment includes equipment operational usage times.

18. A method of doing business as recited in claim 8 wherein electronically monitoring equipment includes monitoring equipment historical fault conditions and operational data.

19. A method of doing business as recited in claim 8 wherein said maintenance schedules are adaptively alterable based upon information received in connection with monitoring said equipment.
